(19) United States
(12) Patent Application Publication
(10) Pub. No.: US 2007/0124071 A1
(43) Pub. Date: May 31, 2007

(54) System for providing 3-dimensional vehicle information with predetermined viewpoint, and method thereof

(76) Inventors: In-Hak Joo, Daejon (KR); Gee-Ju Chae, Daejon (KR); Seong-Ik Cho, Daejon (KR); Jong-Hyun Park, Daejon (KR)

Correspondence Address: LADAS & PARRY LLP, 224 SOUTH MICHIGAN AVENUE, SUITE 1600, CHICAGO, IL, 60604, US

(21) Appl. No.: 11/542,562

(22) Filed: Oct. 3, 2006

(30) Foreign Application Priority Data
Nov. 30, 2005 (KR) 10-2005-0115838

(51) Int. Cl. G01C 21/00

(52) U.S. Cl. 701/211; 701/200

(57) ABSTRACT

Provided is a system for providing 3-dimensional (3D) vehicle information with a predetermined viewpoint by grasping circumstances such as other vehicles and road facilities in an outside of a user's vehicle, and a method thereof. The system includes: an internal sensing unit for acquiring raw material data used to determine a location of the user's vehicle; an external sensing unit for acquiring raw material data; a storing unit for storing coordinates of roads and major road facilities, and relationship between user's vehicle and the road or the major road facilities; an inferring unit for operating, determining object information and inferring a relationship between vehicles; a rendering unit for reorganizing object data including user s vehicle information determined in the inferring unit in a 3D graphic form; and an output unit for outputting 3D graphic data reorganized in the rendering unit to an output device.

### FIELD OF THE INVENTION

The present invention relates to a system for providing 3-dimensional (3D) vehicle information with a predetermined viewpoint by grasping outer circumstances of a user's vehicle such as other vehicles and road facilities, and a method thereof; and, more particularly, a system for providing 3D vehicle information with a predetermined viewpoint to a driver by grasping his/her location through sensors attached to the vehicle, determining the location, distance, direction, and speed of other vehicles and road facilities through an electronic map and the user's location by detecting other vehicles and road facilities, reorganizing information of the user's vehicle, other vehicles and road facilities in a 3D graphic form, and outputting the information through an output device such as a display terminal and Head-Up Display (HUD), and a method thereof.

### DESCRIPTION OF RELATED ART

Generally, side mirrors and a rear-view mirror are used for a driver to grasp information of roads and other vehicles. However, using the mirrors is not safe for the driver cannot keep his/her eyes on the front constantly. Also, the driver cannot intuitionally determine the location and distance, speed, and direction of other vehicles based on his/her vehicle from the mirrors. In addition, the driver cannot recognize other vehicles in a dead zone according to an angle of the mirrors.

Accordingly, methods of using a real image by mounting a camera outside of a vehicle have been developed to complement the methods using the mirrors in a related technology field. However, even though an image is formed by combining many images acquired from a plurality of cameras, the formed image is different from actual scene due to differences in directions and angles of view of the cameras. Accordingly, there is a problem that it is difficult to grasp the real circumstances.

Further, it is not possible to photograph the user's vehicle and include the photographed image in the entire image in the conventional methods, and the photographed image is of a fixed viewpoint, so the conventional methods still have a problem that it is difficult to grasp the location, distance, speed, and direction of other vehicles based on the user's vehicle.

### SUMMARY OF THE INVENTION

It is, therefore, an object of the present invention to provide a system and method for providing 3-dimensional (3D) vehicle information with a predetermined viewpoint by detecting/measuring the location, distance, direction, and speed of other vehicles through sensors mounted in a user's vehicle, reorganizing circumstances of the vehicle and surrounding roads in a 3D graphic form, and outputting the circumstance information in an output device such as a display terminal or a Head-Up Display (HUD).

It is another object of the present invention is to provide a system and method for providing 3D vehicle information with a predetermined viewpoint to output an image of a predetermined viewpoint desired by the user by transforming the viewpoint of an acquired 3D image into an image through movement, rotation, and zoom/unzoom.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a system for providing 3D vehicle information with a predetermined viewpoint, the system including: an internal sensing unit for acquiring raw material data used to determine a location of the user's vehicle; an external sensing unit for acquiring raw material data used to determine a location, a distance, a direction, and speed of other vehicles and major road facilities; a storing unit for storing coordinates of roads and major road facilities; an inferring unit for operating and determining object information such as a location of the user's vehicle, a location, a distance, a direction, speed and a size of other vehicles and major road facilities based on the raw material data from the internal/external sensing unit and data stored in the storing unit, and inferring a relationship between vehicles; a rendering unit for reorganizing object data including user s vehicle information outputted and determined in the inferring unit in a 3D graphic form; and an output unit for outputting 3D graphic data reorganized in the rendering unit to an output device.

In accordance with another aspect of the present invention, there is provided a method for providing 3D vehicle information with a predetermined viewpoint, including the steps of: a) acquiring first raw material data used to determine a location of the user s vehicle and second raw material data used to determine a location, a distance, a direction, and speed of other vehicles and major road facilities; b) processing the acquired first raw material data, calculating the location of the user's vehicle, and correcting the location of the user's vehicle by coordinates on the road based on a navigation map and an elevation(topography) database; c) performing a comparison operation on information of each object acquired by recognizing the each object from the acquired second raw material data, a part of raw material data and information on a relationship between object and raw material data, such as a location, a moving direction, speed, and an electronic map of the user's vehicle, and determining a location, a distance, a direction, and speed of each external object; d) reorganizing the determined object data including user's vehicle information in a 3D graphic form; and e) outputting the reorganized 3D graphic data to an output device.

The present invention makes it easy to grasp physical relationship between the user's vehicle and other vehicles such as relative location, a distance, and a direction by providing the physical relationship information on a display terminal and provides more intuitional information by having the user see an image in a desired viewpoint differently from the conventional method for grasping the location of other vehicles from an image obtained by the mirrors or an image combined from acquired images by external cameras. Also, since the present invention does not interrupt the user from looking at the front, the user can easily grasp the location and status of other vehicles without decreasing the level of safety of driving.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a 3-dimensional (3D) vehicle information providing system in accordance with an embodiment of the present invention;

FIG. 2 shows a screen of a viewpoint located backward of a user's vehicle, which is outputted on a display terminal mounted on a dash board; and

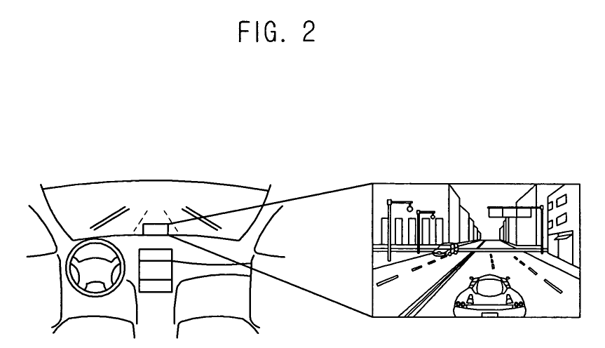

FIG. 3 is a flowchart describing a method for providing 3D vehicle information with a predetermined viewpoint in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

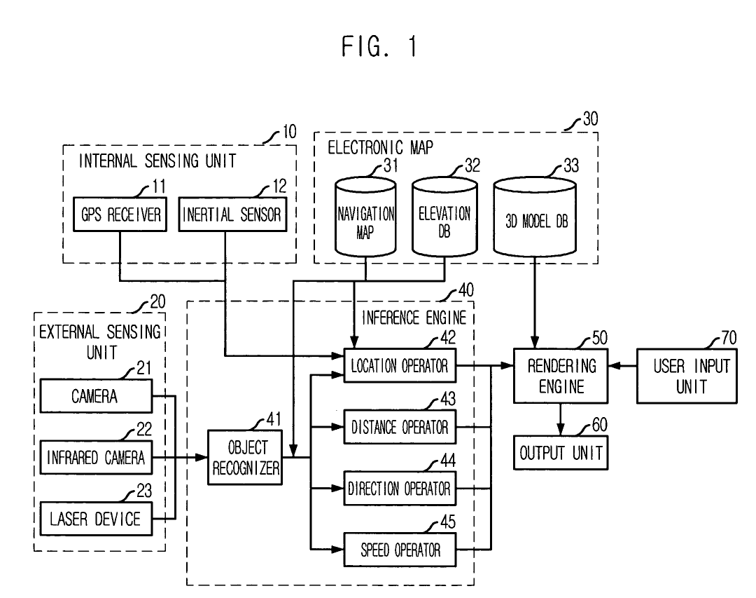

FIG. 1 is a block diagram showing a system providing 3-dimensional (3D) information with a predetermined viewpoint in accordance with an embodiment of the present invention.

The 3D vehicle information providing system of the present invention includes an internal sensing unit 10, an external sensing unit 20, an electronic map 30, an inference engine 40, a rendering engine 50, and an output unit 60.

The internal sensing unit 10 acquires raw material data used to determine a location of a user's vehicle.

The external sensing unit 20 acquires raw material data used to determine the location, distance from the user's vehicle, direction, and speed of other vehicles and major road facilities.

The electronic map 30 stores a relationship with coordinates of a road and major road facilities.

The inference engine 40 operates and determines object information such as a location of the user's vehicle, the location, distance from the user's vehicle, direction, speed, and size of other vehicles and major road facilities based on raw material data from the internal/external sensing units 10 and 20 and data from the electronic map 30, and infers relationship between vehicles.

The rendering engine 50 reorganizes object data outputted and determined in the inference engine 40 into a 3D graphic form.

The output unit 60 outputs the 3D graphic data reorganized in the rendering engine 50 to an output device such as a display terminal or a Head-Up Display (HUD).

The 3D vehicle information providing system further includes a user input unit 70 for receiving information determining an output form and a viewpoint of the 3D graphic data from a user, and transmitting the information to the rendering engine 50. Accordingly, the rendering engine 50 transforms the 3D graphic data into graphic data of a predetermined viewpoint based on the information transmitted from the user input unit 70, i.e., further performs functions of movement, rotation, and zoom/unzoom, and transmits the data to the output unit 60.

The internal sensing unit 10 includes a Global Positioning System (GPS) receiver 11 for acquiring present location information and an inertial sensor 12 for acquiring present attitude information of the users vehicle.

The external sensing unit 20 is formed by combining a plurality of devices among optical sensors such as a laser device 23, an infrared camera 22, and a camera 21 or a camcorder.

The electronic map 30 includes a navigation map 31 for storing a navigation map, an elevation(topography) database (DB) 32 for storing elevation of geographical features, and a 3D model DB 33 for storing information on the shape, color and texture of an object.

The inference engine 40 includes an object recognizer 41, a location operator 42, a distance operator 43, a direction operator 44, and a speed operator 45.

The object recognizer 41 recognizes each object from raw material data transmitted from the external sensing unit 20 and transmits information of each object, part of the raw material data, and information showing connection between the object and the raw material data to the location operator 42, the distance operator 43, the direction operator 44, and the speed operator 45.

The location operator 42 processes the raw material data transmitted from the internal sensing unit 10, calculates a location of the user's vehicle, accesses to the navigation map 31 and the elevation DB 32 of the electronic map 30, corrects the location of the user's vehicle by coordinates on the road based on a map matching method, performs a comparison operation on the information of each object, the part of the raw material data and the connection information between the object and the raw material data transmitted from the object recognizer 41, and determines each location, distance, direction, and speed of external objects.

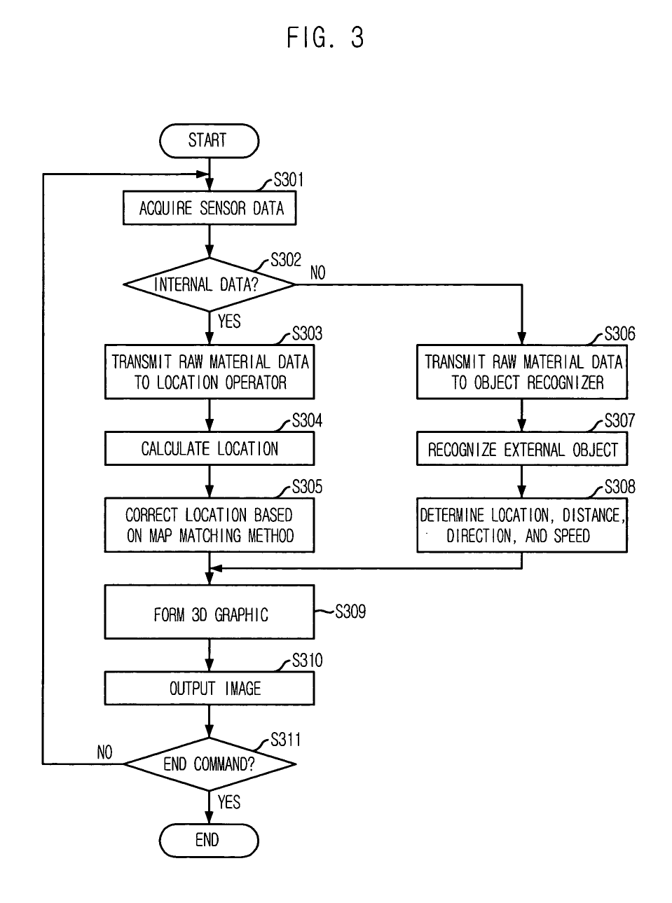

FIG. 3 is a flowchart describing a method for providing 3D vehicle information with a predetermined viewpoint in accordance with the embodiment of the present invention.

The internal sensing unit 10 and the external sensing unit 20 continuously acquire data while driving at step S301. The GPS receiver 11 and the inertial sensor 12 of the internal sensing unit 10 acquire and transmit the raw material data to the location operator 42 of the inference engine 40 at steps S302 and S303.

The location operator 42 processes the raw material data transmitted from the internal sensing unit 10, calculates the location of the user's vehicle at step S304, accesses to the navigation map 31 and the elevation DB 32 of the electronic map 30, and corrects the location of the user's vehicle by the coordinates on the road based on the map matching method at step S305. Since the elevation DB 32 includes topographic height information of the roads, it is possible to acquire exact 3D coordinates of the present location while driving.

Simultaneously, sensors including the camera 21, the infrared camera 22, and the laser device 23 of the external sensing unit 20 acquire and transmits raw material data related to objects such as a road boundary, a traffic light, signs, other vehicles, and pedestrians to the object recognizer 41 of the inference engine 40 at steps S302 and S306. The object recognizer 41 recognizes each object in the raw material data transmitted from the external sensing unit 20 at step S307 and transmits information of the object unit, a part of the raw material data and connection information between the object and the raw material data, if necessary, to the location operator 42, the distance operator 43, the direction operator 44, and the speed operator 45. The location operator 42, the distance operator 43, the direction operator 44, and the speed operator 45 perform comparison operation on the information of the object, the part of the raw material data and the connection information between the object and the raw material data transmitted from the object recognizer 41 with the location, a moving direction, speed of the user's vehicle, and electronic map, and determines location, distance, direction, and speed of external objects, respectively, at step S308.

To be specific, the object information determining processes includes the steps of identifying the kind of the object based on the shape and the color of the object, e.g., a passenger car, a truck, a pedestrian and facilities, estimating and calculating a distance of the object through comparison with size information for each kind of the objects. The direction of the object is calculated based on a moving direction of the user's vehicle, an axis of the sensor and a data value of the sensor, a pixel coordinates value corresponding to the object in an image. The speed of the object is calculated based on a difference between locations of the object calculated at 1/30 second and a present time, a distance of the object, and speed of the user's vehicle determined from the location of the user's vehicle calculated in a speed indicator of the user's vehicle or in the location operator 42.

The determined object information is transmitted to the rendering engine 50. The rendering engine 50 accesses to information of the 3D model DB 33 including information of a shape, a color, and a texture to perform rendering on the transmitted objects' information including user's vehicle information, and acquires rendering information of each object. At step S309, the rendering engine 50 creates an image for a road of a 3D graphic form and the object having a viewpoint at predetermined location (distance and angle with regard to the user's vehicle) based on a present location of the calculated user's vehicle, a location of the external object and rendering information.

The rendering engine 50 receives information for determining an output form and a viewpoint of the 3D graphic data through the user input unit 70 from the user and further performs a function of transforming the 3D graphic data into graphic data of a predetermined viewpoint based on the information transmitted from the user input unit 70, i.e., functions of movement, rotation, and zoom/unzoom.

That is, the user can freely control viewpoint transformation of the created 3D graphic image, such as rotation, movement and zoom/unzoom of the 3D graphic image, and object kind on/off by changing variables of the rendering engine 50. The user input unit 70 can change the variable of the user. Accordingly, the 3D graphic image can be easily controlled without a physical device for changing a direction or angle of view of an external sensing unit in a vehicle.

The created image is transmitted to the output unit 60 and outputted by the output device such as the display terminal or the HUD at step S310. The output device generally includes a Personal Digital Assistant (PDA), a mobile phone and a display device of a navigation device. The output device including the HUD outputs the image on a windshield of the vehicle.

Each process is repeatedly performed in real-time from the sensor data acquisition process of the step S301 until an end command of the user is performed at step S311. In an operation process of each procedure, the data acquired or processed in a previous time unit are stored for a predetermined period and can be used to an operation of next input data. For example, since the external object does not rapidly move in a short time interval, it is possible to reduce search and operation time by applying the recognition result in the previous image when the object is recognized in continuously inputted camera images.

The present invention enable the user to intuitively estimate relational location of the user's vehicle, a distance, and a direction and acquire information of a dead zone of a mirror by operating the location, the distance, the direction and the size of the user's vehicle, other vehicles, and major road facilities through data collected from the internal/external sensing units mounted on the vehicle and an electronic map, forming and outputting the objects in a 3D graphic form differently from the conventional method using mirrors including a side mirror and a room mirror.

Also, the present invention can provide an image including user's vehicle differently from the conventional method which provides only external information of the vehicle using an image acquired in a mirror or an external camera. Accordingly, the user can intuitively estimate relationship between user's vehicle and other vehicles, or between user's vehicle and the road facilities.

Since the present invention can process an image in an image rendering engine without a device for changing a direction or an angle of view in an external sensor of a vehicle, viewpoint transformation of the provided 3D image, i.e., rotation, movement, and zoom/unzoom of the 3D image, can be performed freely.

That is, the present invention provides information on circumstances including other vehicles and flexibly uses an output device such as a display terminal and the HUD without being limited to the mirror. Accordingly, the user can concentrate on driving by watching at the front and it helps user's safe driving.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0115838, filed with the Korean Intellectual Property Office on Nov. 30, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A system for providing 3-dimensional (3D) vehicle information with a predetermined viewpoint, comprising:
an internal sensing means for acquiring raw material data used to determine a location of a user's vehicle;
an external sensing means for acquiring raw material data used to determine a location, a distance, a direction, and speed of other vehicles and major road facilities;
a storing means for storing coordinates of roads and major road facilities, and relationship between user's vehicle and the roads or the major road facilities;
an inferring means for operating, determining object information including a location of the user's vehicle, a location, a distance, a direction, speed and a size of other vehicles and major road facilities based on the raw material data from the internal/external sensing means and data stored in the storing means, and inferring a relationship between vehicles;
a rendering means for reorganizing objects' data including user's vehicle information determined in the inferring means in a 3D graphic form; and
an output means for outputting 3D graphic data reorganized in the rendering means to an output device.

2. The system as recited in claim 1, further comprising:
a user input means for receiving information determining an output form and a viewpoint of the 3D graphic data from a user and transmitting the information to the rendering means,
wherein the rendering means further performs a function of transforming the 3D graphic data into graphic data of a predetermined viewpoint based on the information transmitted from the user input means and transmits the graphic data of the predetermined viewpoint to the output means.

3. The system as recited in claim 1, wherein the inferring means includes:
an object recognizer for recognizing each object from the raw material data transmitted from the external sensing means and transmitting information of each object, a part of raw material data, and/or information showing connection between the object and the raw material data; and
an operating block for processing the raw material data transmitted from the internal sensing means, calculating a location, accessing to a navigation map of the storing means and an elevation database (DB), correcting a location of the user's vehicle by coordinates on the road, performing a comparison operation on information of each object transmitted from the object recognizer, a part of the raw material data, and object-raw material data connection information with a location, a moving direction, speed, and an electronic map of the user's vehicle, and determining each location, distance, direction, and speed of the external object.

4. The system as recited in claim 3, wherein the operating block includes: a location operator, a distance operator, a direction operator, and a speed operator

5. The system as recited in claim 3, wherein the output means outputs the 3D graphic data reorganized in the rendering means to a Head-Up Display (HUD).

6. A method for providing 3-dimensional (3D) vehicle information with a predetermined viewpoint, comprising the steps of:
a) acquiring first raw material data used to determine a location of a user's vehicle and second raw material data used to determine a location, a distance, a direction, and speed of other vehicles and major road facilities;
b) processing the acquired first raw material data, calculating the location of the user's vehicle, and correcting the location of the user's vehicle by coordinates on the road based on a navigation map and an elevation database;
c) performing a comparison operation on information of the each object acquired by recognizing the each object from the acquired second raw material data, a part of raw material data and object-raw material data connection information with a location, a moving direction, speed, and an electronic map of the user's vehicle, and determining a location, a distance, a direction, and speed of each external object;
d) reorganizing the determined object data including the user's vehicle information in a 3D graphic form; and
e) outputting the reorganized 3D graphic data to an output device.

7. The method as recited in claim 6, further comprising the step of:
f) receiving information for determining an output form and a viewpoint of the 3D graphic data from the user.

8. The method as recited in claim 7, further comprising the step of:
g) transforming the 3D graphic data into graphic data of a predetermined viewpoint based on the inputted information.

9. The method as recited in claim 7, further comprising the step of:
h) selecting/deselecting a kind of an object to be displayed.
